(19) United States
(12) Patent Application Publication
(10) Pub. No.: US 2015/0163283 A1
(43) Pub. Date: Jun. 11, 2015

(54) DATA REUSE METHOD AND ELECTRONIC DEVICE

(71) Applicant: Samsung Electronics Co., Ltd., Gyeonggi-do (KR)

(72) Inventor: Youngjun Seo, Gyeonggi-do (KR)

(21) Appl. No.: 14/562,078

(22) Filed: Dec. 5, 2014

(30) Foreign Application Priority Data
Dec. 5, 2013 (KR) 10-2013-0150424

(51) Int. Cl. H04L 29/08; H04L 29/06

(52) U.S. Cl. CPC H04L 67/06; H04L 65/60

(57) ABSTRACT

A method and electronic device is provided for downloading multimedia contents efficiently. The data reuse method of the present disclosure includes receiving a partial data of a multimedia content through a streaming service. The data reuse method also includes formatting media data based on indexing information of the partial data. The data reuse method also includes storing the media data in a memory. The data reuse method also includes downloading, when a request for downloading the multimedia content, remaining media data with the exception of the stored media data.

### CROSS-REFERENCE TO RELATED APPLICATION(S) AND CLAIM OF PRIORITY

The present application is related to and claims the benefit under 35 U.S.C. §119(a) of a Korean patent application filed on Dec. 5, 2013 in the Korean Intellectual Property Office and assigned Serial No. 10-2013-0150424, the entire disclosure of which is hereby incorporated by reference.

### TECHNICAL FIELD

The present disclosure relates to a method and electronic device for downloading multimedia contents efficiently.

### BACKGROUND

Contents services are classified into two types: streaming service and download service. With the streaming service, the content received through a network is buffered temporarily and then discarded after being provided to the user. In the download service, the content received through the network is stored in a memory so as to be provided to the user whenever requested.

### SUMMARY

To address the above-discussed deficiencies, it is a primary object to provide a data reuse method and device that is capable of reducing data consumption amount by reusing the data of the multimedia content which has been already received through the streaming service for the download service in response to the request for download of the same content.

In accordance with an aspect of the present disclosure, a data reuse method includes receiving a partial data of a multimedia content through a streaming service. The data reuse method also includes formatting media data based on indexing information of the partial data. The data reuse method also includes storing the media data in a memory. The data reuse method also includes downloading, when a request for downloading the multimedia content, remaining media data with the exception of the stored media data.

In accordance with another aspect of the present disclosure, a data reuse method includes receiving a streaming content. The data reuse method also includes storing media data to be reused in a memory according to a result of analyzing the received streaming content. The data reuse method also includes downloading, when a request for whole data of the streaming content, remaining media data with the exception of the stored media data.

In accordance with still another aspect of the present disclosure, an electronic device includes a receiver that receives partial data of a multimedia content through a streaming service. The electronic device also includes a control unit which configures media data to be reused based on indexing information of the partial data The electronic device also includes a memory that stores the media data The electronic device also includes a downloader which downloads, when a request for downloading the multimedia content, remaining media data configuring the multimedia content without the exception of the stored media data under the control of the control unit.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process for a data reuse method according to an embodiment of the present disclosure. The data reuse method of the present disclosure may operate in an electronic device;

FIG. 2 illustrates a diagram showing a multimedia content download operation through the streaming service according to an embodiment of the present disclosure;

FIG. 3 illustrates a diagram showing an example format of the media data according to an embodiment of the present disclosure;

FIG. 4 illustrates a diagram showing an example multimedia content download operation according to an embodiment of the present disclosure;

FIG. 5 illustrates a process for a data reuse method according to another embodiment of the present disclosure;

FIG. 6 illustrates a block diagram showing a configuration of the electronic device according to an embodiment of the present disclosure.

### DETAILED DESCRIPTION

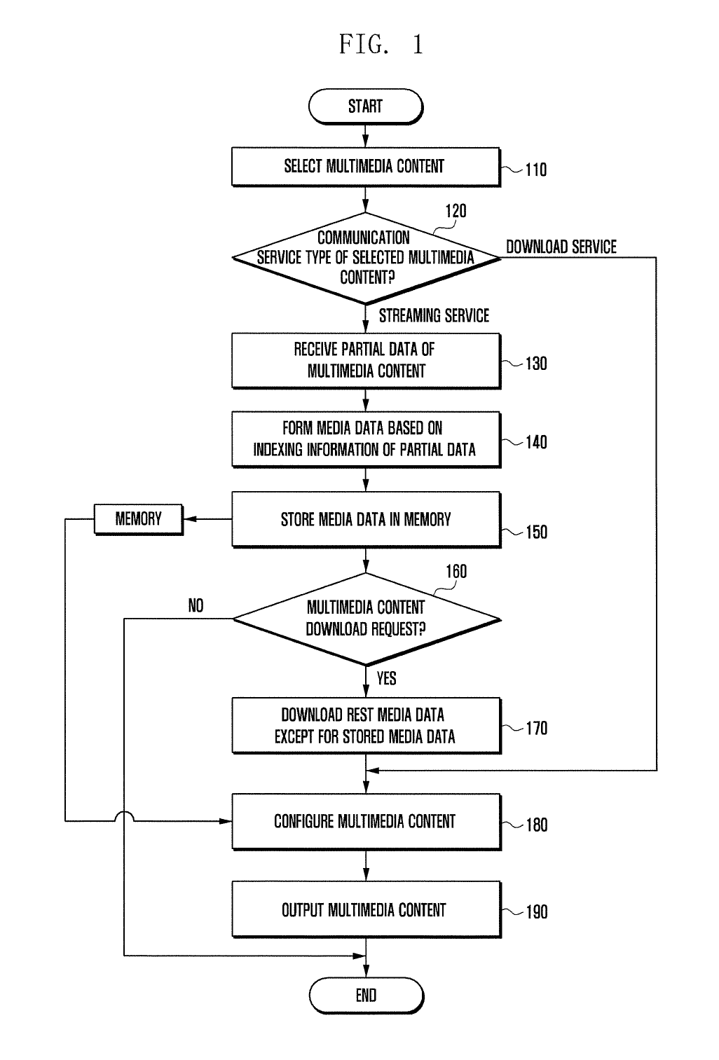

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Exemplary embodiments of the present disclosure are described with reference to the accompanying drawings in detail. The same reference numbers are used throughout the drawings to refer to the same or like parts. Detailed description of well-known functions and structures incorporated herein may be omitted to avoid obscuring the subject matter of the present disclosure. This aims to omit unnecessary description so as to make the subject matter of the present disclosure clear.

The device according to an embodiment of the present disclosure is equipped with a communication function. The device may be any or a combination of at least two of smartphone, tablet Personal Computer (PC), mobile phone, video phone, electronic book (e-book) reader, desktop PC, laptop PC, netbook computer, Personal Digital Assistant (PDA), Portable Multimedia Player (PMP), MP3 player, mobile medical device, electronic bracelet, electronic necklace, electronic appcessary, camera, wearable device, electronic clock, wrist watch, home appliance (e.g. refrigerator, air-conditioner, vacuum cleaner, oven, microwave oven, laundry machine, air ventilator, and the like), artificial intelligence robot, Television (TV), Digital Video Disk (DVD) player, audio, medical device (e.g. Magnetic Resonance Angiography (MRA), Magnetic Resonance Imaging (MRI), Computed Tomography (CT) system, ultrasonic machine, and the like), navigation device, Global Positioning System (GPS) receiver, Event Data Recorder (EDR), Flight Data Recorder (FDR), set-top box, TV box (e.g. Samsung HomeSync™, Apple™, Google TV™, and the like), electronic dictionary, car infotainment device, electronic equipment for ship (e.g. maritime navigation device, gyro compass, and the like), aviation electronic device (avionics), security device, electronic clothing, electronic key, camcorder, game consoles, Head-Mounted Display (HMD), flat panel display device, electronic frame, electronic album, furniture and building/structure having a communication function, electronic board, electronic signature receiving device, and projector. It is obvious to those skilled in the art that the electronic device is not limited to the aforementioned devices.

Once the buffered streaming service content has been provided to the user, the corresponding data is discarded other than being stored in the memory. When using the streaming service, the buffered data is a part of the whole content. Accordingly, the user may request for downloading of the whole content after watching or listening to the content. This means that, since the content consumed through the streaming service vanishes, the user has to receive the whole content again redundantly in order to store the whole content in the memory. In this embodiment, the same content is received twice so as to cause overload to the communication network or server.

FIG. 1 illustrates a process for a data reuse method according to an embodiment of the present disclosure. The data reuse method of the present disclosure may operate in an electronic device.

Referring to FIG. 1, the electronic device receives a user input for selecting a multimedia content at block 110. The multimedia content means a collective work made up of various formats of information such as text, voice, and video. For example, the multimedia content may include various data of music, picture, photo, cartoon, movie, and the like. The user may select one of the various types of multimedia contents presented by means of the electronic device.

The electronic device may check the type of the communication service for delivery of the selected multimedia content at block 120. For example, the communication service may be one of the streaming service and the downlink service. With the streaming service, the content received through a network is buffered temporarily and then discarded after being provided to the user. With the download service, the content received through the network is stored in a memory persistently so as to be provided to the user whenever requested. If the communication service is the streaming service, the procedure goes to block 130 and, otherwise if the communication service is the download service, block 180.

At block 130, the electronic device receives partial data of the selected multimedia content. The partial data is a part of the multimedia content. In an embodiment, the streaming service is provided in the form of a stream of the data configuring the multimedia content such that the data received at a certain time is a part of the multimedia content. The user may request for the whole data of the multimedia content after watching or listening the multimedia content provided through the streaming service. In the conventional method, however, the multimedia content received through the streaming service is discarded after being watched or listened by the user.

The present disclosure aims to provide a method for extracting the media data reusable among the partial data of the multimedia content received through the streaming service and storing the extracted data in a storage space for reuse afterward.

In order to accomplish this, the electronic device processes the partial data into a media data based on the indexing information thereof at block 140. The media data can be used in downloading the multimedia content afterward. The multimedia content is a collective work made up of a plurality of media data. The indexing information denotes an index for identifying the media data such that a multimedia data match an indexing information (or index).

Since the partial data includes some media data of the multimedia content, the electronic device stores the media data in match with the indexing information such that the stored media data are excluded in downloading the multimedia content in response to the user request afterward.

The electronic device stores the processed media data in the memory at block 150. The memory may be internal storage space of the electronic device. The memory may store the media data by index.

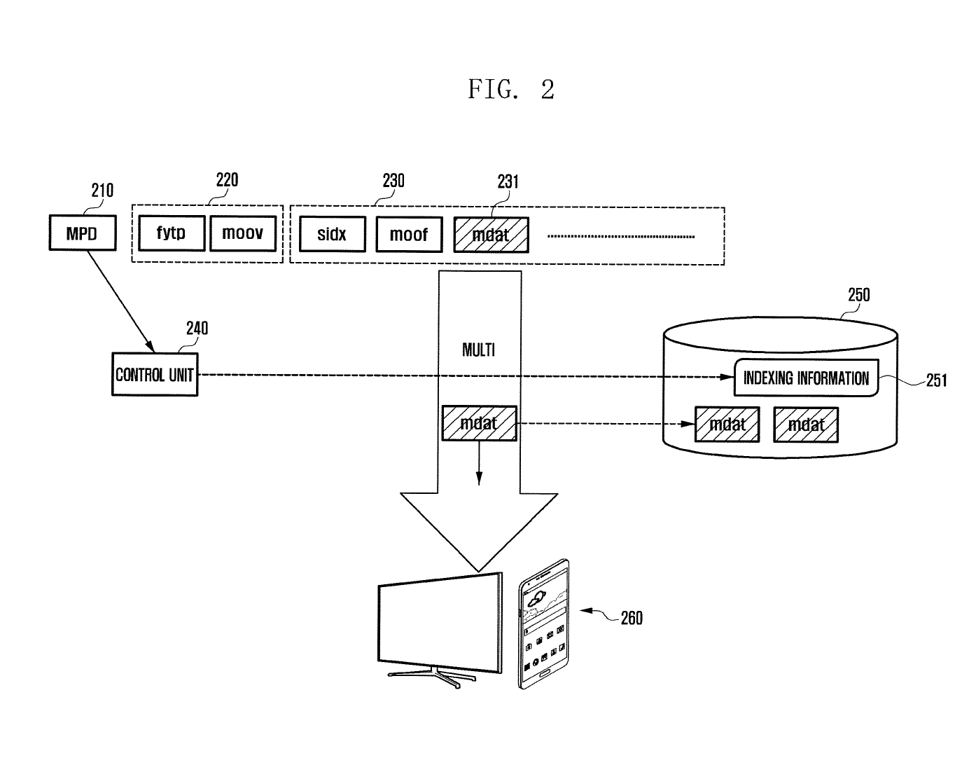

FIG. 2 illustrates a diagram showing a multimedia content download operation through the streaming service according to an embodiment of the present disclosure.

Referring to FIG. 2, the electronic device may receive the partial data 210 of the multimedia content through the streaming service. The partial data 210 is a Media Presentation Description (MPD) file which may include information about the multimedia content and location information of the media data. The MPD file may have an information field 220 including File Type Box (ftyp) and Movie Box (moov). The MPD file also may having an information field 230 including Segment Index Box (sidx) of the multimedia content provided currently in the streaming service, Movie Fragment (moof), and media data (231). Here, the media data 231 includes video or audio to be output through the display device 260.

The control unit 240 of the electronic device extracts reusable media data from the received partial data and stores the extracted media data in the memory 250. That is, the control unit 240 can extract the media data from the partial data and matches the extracted media data to the indexing information based on the indexing information of the partial data. The memory 250 may store the media data by indexing information 251.

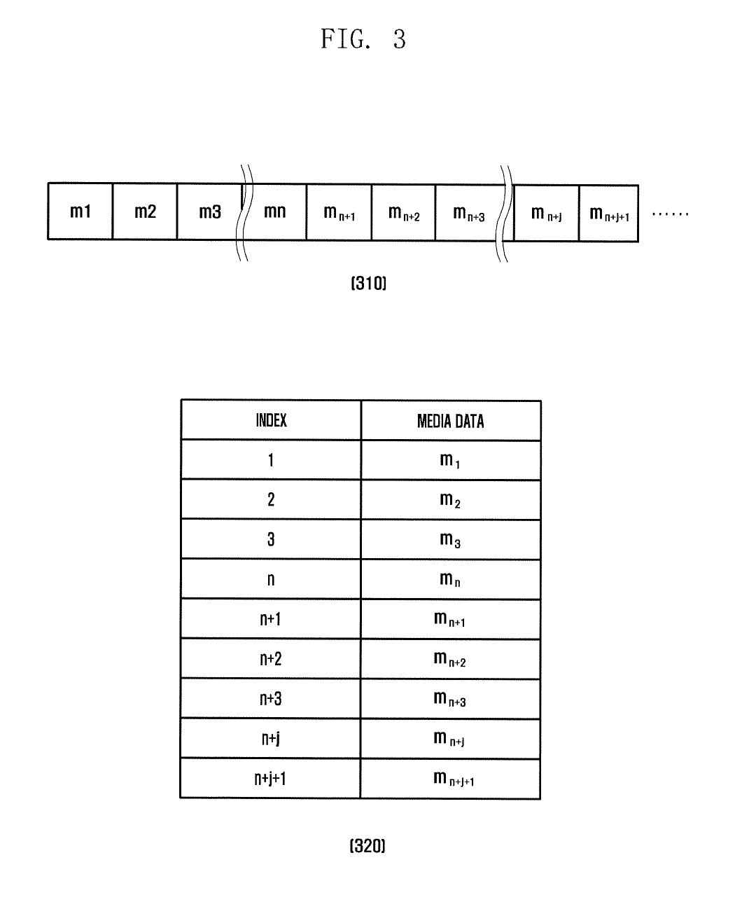

FIG. 3 illustrates a diagram showing an example format of the media data according to an embodiment of the present disclosure.

Referring to FIG. 3, the multimedia content is made up of a plurality of media data 310. The partial includes some of the media data configuring the multimedia content. Assuming that the multimedia content consists of 10,000 media data, the partial data may be made of 100 of 10,000 media data. In this embodiment, if a request for download of the multimedia content is input, the electronic device checks the 100 media data received through the streaming service based on the indexing information and processes the checked media data into a partial data so as to receive the remaining 9,900 media data with the exception of the partial data, i.e. 100 media data. For example, the electronic device may store the media data (m₁, m₂, m₃, mₙ, mₙ₊₁, mₙ₊₂, mₙ₊ⱼ, and mₙ₊ⱼ₊₁) in match with the indices (1, 2, 3, n, n+1, n+2, n+3, n+j, n+j+1) within the memory as denoted by reference number 320. Afterward, if a request for downloading of the multimedia content is received, the electronic device downloads the media data of the multimedia content with the exception of the media data stored in the memory.

Returning to FIG. 1, the electronic device monitors to detect a request for downloading of the multimedia content at block 160. That is, the user may determine to download the whole data of the multimedia content after checking the partial data received through the streaming service.

If the request for downloading of the multimedia content is detected, the electronic device downloads the multimedia content with the exception of the media data stored already as the partial data. When downloading the multimedia content, the electronic device may compare the received the media content with the media data stored in the memory to download only the residual media data not stored in the memory. According to an embodiment, the electronic device receives the header information of the multimedia content and compares the index contained in the header information with the indices of the stored media data to download only the media data having mismatched indices. The electronic device may download the media data having the index mismatching any of the indices of the media data stored in the memory.

In this way, the data reuse method and device according of the present disclosure is capable of reducing data consumption amount by reusing the media data content received already through the streaming service as a part of the multimedia content in downloading the whole multimedia service in response to the user request afterward. In an embodiment, the multimedia content download cost is determined based on the data consumption amount. This means that it is possible to reduce the entire data consumption amount by avoiding redundant download of the media data which has been received already through the streaming service before the detection of the download request.

The electronic device configures the multimedia content at block 180. When using receiving the multimedia content through the download service after receipt of the same through the streaming service, the electronic device is capable of integrating the media data received through the streaming and download services into the multimedia content. That is, the electronic device is capable of patching the media data received through the streaming service to the media data received through the download service so as to configure the whole multimedia data. Configuring the multimedia data is aligning the media data in sequence based on the indexing information.

If the communication service is the download service at block 120, the electronic device downloads the whole multimedia content and stores the multimedia content in a format capable of being output through a display and/or a speaker at block 180.

The electronic device outputs the multimedia content at block 190. Here, outputting the multimedia content is displaying video through the display of the electronic device and outputting audio through an audio processing unit of the electronic device.

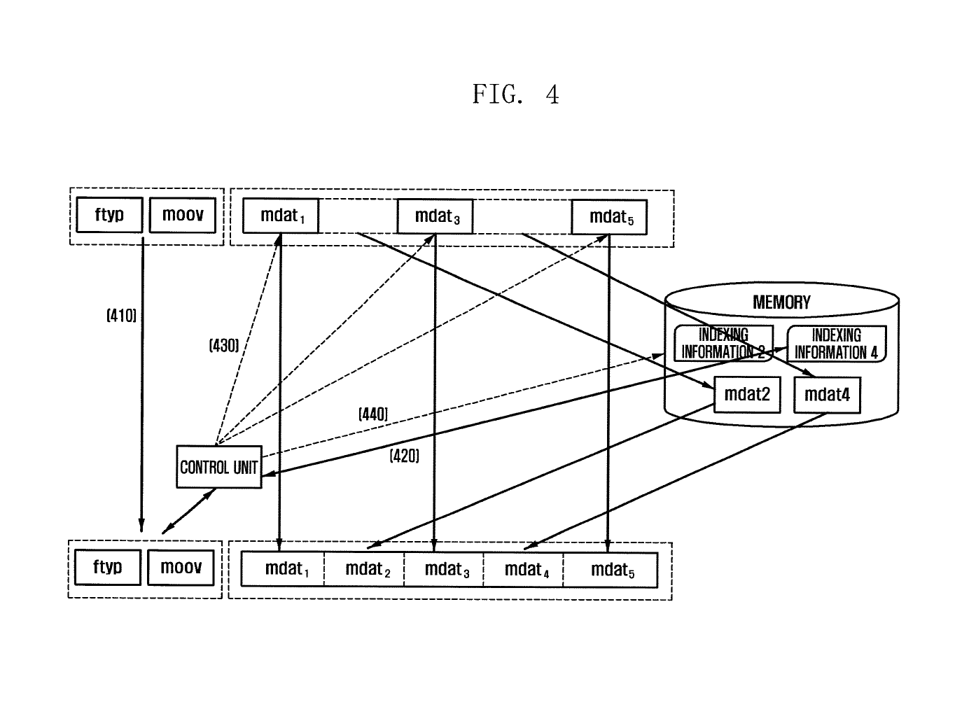

FIG. 4 illustrates a diagram showing an example multimedia content download operation according to an embodiment of the present disclosure.

Referring to FIG. 4, if a multimedia content download request is received, the electronic device may download the header information 410 of the multimedia content. The electronic device may compare the indices included in the header information with the indices of the previously stored media data as denoted by reference number 420. For example, the electronic device compares the index of media data “mdat 1” which is included in the header information with the indices stored in the memory and, if there is no match, downloads the media data “mdat 1” as denoted by reference number 430. The electronic device also may compare the index of media data “mdat 2” which is included in the header information with the indices of the previously stored media data and, if there is any match, skip downloading the media data “mdat 2” as denoted by reference number 440.

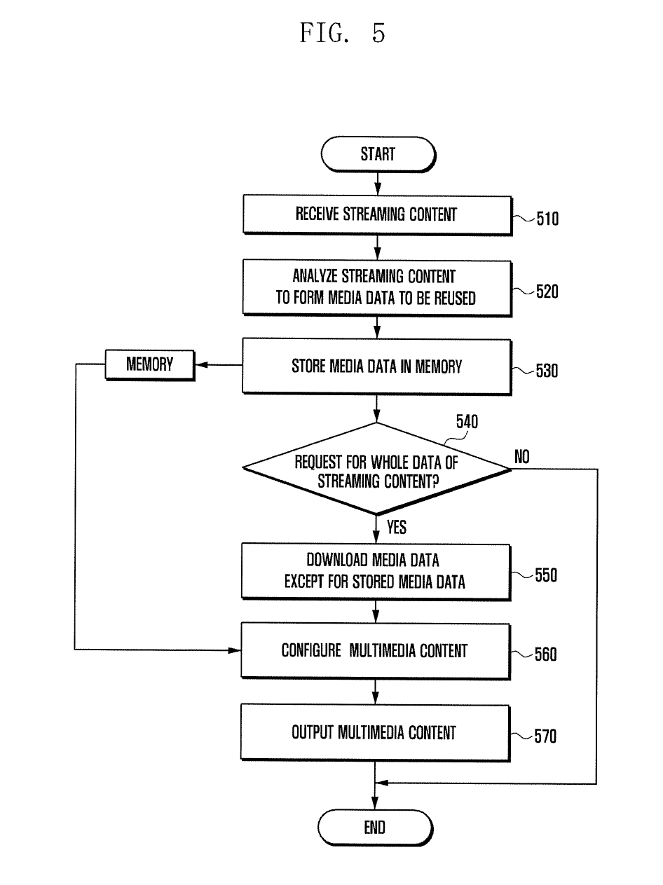

FIG. 5 illustrates a process for a data reuse method according to another embodiment of the present disclosure.

Referring to FIG. 5, the electronic device receives streaming content at block 510. The streaming content is the content received through a streaming service.

The electronic device analyzes the received streaming content to format media data to be reused at block 520. The electronic device extracts the media data from the streaming content for reuse by index based on the indexing information of the streaming content.

The electronic device stores the formatted media data in the memory at block 530. The electronic device may store the media data in the memory by index.

The electronic device monitors to detect a request for downloading the whole data of the streaming content at block 540. If the download request is detected in predetermined time, the procedure goes to block 550 and, otherwise, the procedure ends.

At block 550, the electronic device downloads the multimedia content with the exception of the stored media data. The electronic device is capable of acquiring the whole data of the multimedia content in such a way of receiving the header information of the streaming content, comparing the indices contained in the header information with the indices of the stored media data, and downloading the media data having the mismatched indices.

The electronic device combines the previously stored media data and the currently downloaded media data into the multimedia content at block 560.

The electronic device outputs the multimedia content at block 570. The electronic device may output the multimedia content through a display unit and/or an audio processing unit.

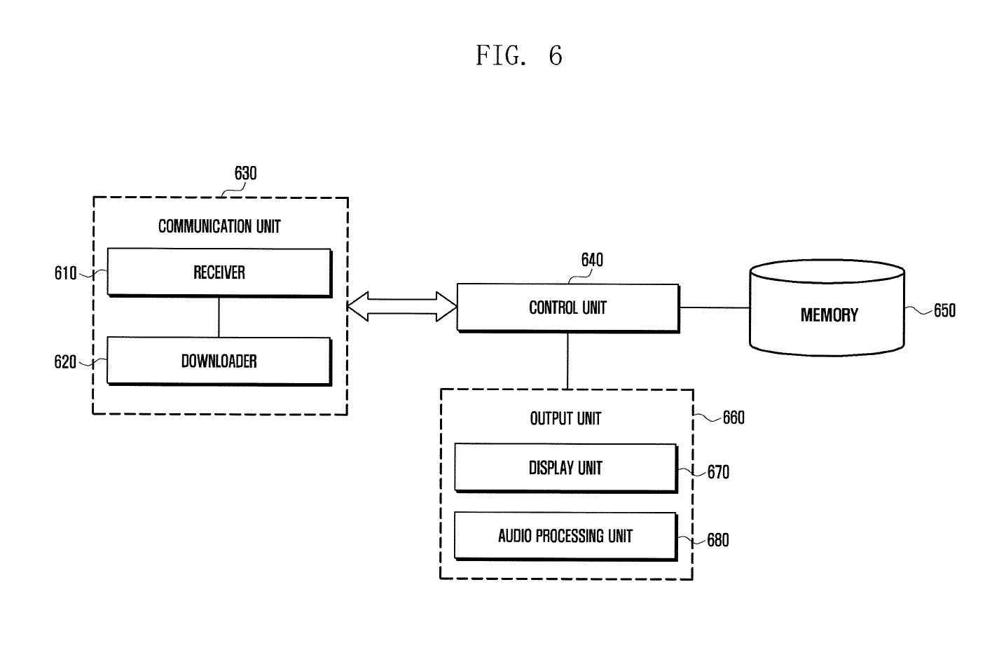

FIG. 6 illustrates a block diagram showing a configuration of the electronic device according to an embodiment of the present disclosure.

Referring to FIG. 6, the electronic device 600 includes a communication unit 630, a control unit 640, a memory 650, and an output unit 660.

The communication unit 630 includes a receiver 610 and a downloader 620. The receiver 610 receives partial data of the multimedia content through a streaming service. The multimedia data may include various types of data such as music, drawing, photo, cartoon, and movie. The partial data may be MPD files.

The communication unit performs voice, video, or data communication with an external device through a network under the control of the control unit 640. The communication unit 630 may include a Radio Frequency (RF) transmitter for performing up-conversion and amplification on the transmission signals and an RF receiver for performing low noise amplification and down-conversion on the received signals. The communication unit 630 also may include at least one of cellular communication module (e.g. 3rd Generation (3G) cellular communication module, 3.5G cellular communication module, and 4G cellular communication module), digital broadcast module (e.g. Digital Multimedia Broadcasting (DMB) module), and short range communication module (e.g. Wireless Fidelity (Wi-Fi) module, Bluetooth module, and Near Field Communication (NFC) module).

The control unit 640 formats the media data in association with the indexing information of the received partial data. The media data are reused in downloading the multimedia content afterward. The multimedia content is made up of a plurality of media data. One index is assigned to one media data as the identifier of the media data. Since the partial data is made up of some of the media data configuring the multimedia content, the control unit 640 downloads, through the download service, the media data of the multimedia content with the exception of the media data stored in match with the indices.

The memory 650 stores the formatted media data. The memory 650 may store the media data by index. The memory 650 is a secondary memory unit of the electronic device such as disk, Random Access Memory (RAM), Read Only Memory (ROM), and flash memory.

If a multimedia content download request is detected, the control unit 640 controls the downloader 620 to download the media data of the multimedia content with the exception of the previously stored media data.

The downloader 620 may download the header information of the multimedia content. The control unit 640 compares the indexing information contained in the header information with the indices of the stored media data to receive only the media data having the mismatching indices. That is, the downloader 620 downloads the remaining media data of which indices are not stored in the memory 650.

For example, the control unit 640 compares the index of the media data “mdat 3” with the indices stored in the memory 650 and, if there is no match, controls the downloader 620 to download the media data “mdat 3.” Also, the control unit 640 compares the index of the media data “mdat 4” with the indices stored in the memory 650 and, if there is any match, controls the downloader 620 to skip downloading the media data “mdat 4.”

The control unit 640 combines the previously stored media data and the downloaded media data into the multimedia content. The multimedia content is configured by aligning the media data in an order of the indices. The control unit 640 patches the media data received previously through the streaming service to the media data received through the download service so as to configure the multimedia content.

The output unit 660 may display the multimedia content. The output unit 660 may include a display unit 670 and an audio processing unit 680.

The display unit 670 may display the multimedia content on the screen under the control of the control unit 640. The display unit 670 may be implemented with one of Liquid Crystal Display (LCD), Organic Light Emitting Diodes (OLED), Active Matrix OLED (AMOLED), and flexible display.

The audio processing unit 680 may output audio included in the multimedia content under the control of the control unit 680. In an embodiment, the audio processing unit 680 includes a speaker (SPK) and a microphone (MIC) for input and output of audio signal (e.g. voice data) in association with the voice recognition, voice recording, digital recording, and telephony functions. The audio processing unit 680 is capable of receiving audio signal from the control unit 640, performs Digital/Analog (D/A) conversion on the analog signal, amplifying the analog audio signal, and outputting the analog audio signal through the speaker. The audio processing unit 680 is capable of performing A/D conversion on the audio signal received through the microphone (MIC) and transferring the digital audio signal to the control unit 640. The speaker (SPK) is capable of outputting the analog audio signal in the form of audible sound wave. The microphone (MIC) converts the sound wave from the sound source such as human to the audio signal.

As described above, the data reuse method and device of the present disclosure is advantageous in terms of reducing data consumption amount by reusing the data of the multimedia content which has been already received through the streaming service for the download service in response to the request for download of the same content.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A data reuse method comprising:
receiving a partial data of a multimedia content through a streaming service;
formatting media data based on indexing information of the partial data;
storing the media data in a memory; and
downloading, after receiving a request for downloading the multimedia content, remaining media data and not comprising the stored media data.

2. The method of claim 1, wherein receiving the partial data comprises receiving a Media Presentation Description (MPD) file as the partial data.

3. The method of claim 1, wherein formatting the media data comprises:
extracting the media data from the partial data; and
mapping indices to the extracted media data based on the indexing information of the partial data.

4. The method of claim 3, wherein storing the media data comprises storing the media data by index.

5. The method of claim 1, wherein downloading the remaining media data comprises:
receiving header information of the multimedia content;
comparing the indexing information included in the header information with the indices of the stored media data; and
downloading the remaining media data depending on a comparison result.

6. The method of claim 5, wherein downloading the remaining media data comprises downloading remaining media data of which indices mismatch with any of the indices of the stored media data.

7. The method of claim 1, further comprising combining the stored media data and the remaining media data into the multimedia content.

8. The method of claim 7, further comprising outputting the multimedia content.

9. A data reuse method comprising:
receiving a streaming content;
storing media data to be reused in a memory according to a result of analyzing the received streaming content; and
downloading, after receiving a request for whole data of the streaming content, remaining media data and not comprising the stored media data.

10. The method of claim 9, wherein storing the media data to be reused comprises:
extracting media data from the streaming content;
mapping indices to the extracted media data based on indexing information of the streaming content; and
storing the media data in the memory by index.

11. The method of claim 9, wherein downloading the remaining media data comprises:
receiving header information of the streaming content;
comparing an index included in the header information with indices of the stored media data; and
downloading the remaining media data of which index matches none of the indices of the media data stored in the memory according to the comparison result.

12. An electronic device comprising:
a receiver configured to receive partial data of a multimedia content through a streaming service;
a control unit configured to configure media data to be reused based on indexing information of the partial data;
a memory configured to store the media data; and
a downloader configured to download, after receiving a request for downloading the multimedia content, remaining media data configuring the multimedia content and not comprising the stored media data under the control of the control unit.

13. The electronic device of claim 12, wherein the receiver is configured to receive a Media Presentation Description (MPD) file as the partial data.

14. The electronic device of claim 12, wherein the control unit is configured to extract the media data from the partial data and maps indices to the extracted media data based on the indexing information of the partial data.

15. The electronic device of claim 14, wherein the memory is configured to store the media data by index.

16. The electronic device of claim 12, wherein the downloader is configured to receive header information of the multimedia content, and the control unit is configured to compare the indexing information included in the header information with the indices of the stored media data and determines download the remaining media data depending on a comparison result.

17. The electronic device of claim 16, wherein the downloader is configured to download the remaining media data of which indices match with none of the indices of the stored media data.

18. The electronic device of claim 12, wherein the control unit is configured to combine the stored media data and the downloaded media data into the multimedia content.

19. The electronic device of claim 18, further comprising an output unit configured to output the multimedia content.

20. The method of claim 9, wherein storing the media data comprises storing the media data by index.
